(19) United States
(12) Patent Application Publication
(10) Pub. No.: US 2010/0147462 A1
(43) Pub. Date: Jun. 17, 2010

(54) METHOD FOR BONDING FLEXIBLE PRINTED CONDUCTOR TRACKS WITH AN ADHESIVE STRIP THAT CAN BE ACTIVATED BY HEAT AND IS BASED ON CARBOXYLATED NITRILE RUBBER

(75) Inventors: Christian Ring, Hamburg (DE); Thorsten Krawinkel, Hamburg (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: tesa SE, Hamburg (DE)

(21) Appl. No.: 12/706,197

(22) Filed: Feb. 16, 2010

Related U.S. Application Data
(62) Division of application No. 11/718,367, filed on Dec. 10, 2008.

(30) Foreign Application Priority Data
Nov. 29, 2004 (DE) 10 2004 057 650.5
Nov. 29, 2004 (DE) 10 2004 057 651.3

(51) Int. Cl. C09J 133/20

(52) U.S. Cl. 156/330

(57) ABSTRACT

Heat-activable adhesive tape for producing and further processing flexible conductor tracks, with an adhesive composed at least of
a. an acid- or acid anhydride-modified acrylonitrile-butadiene copolymer, and
b. an epoxy resin,
   the weight ratio of the two components a/b being greater than 1.5 and no additional nonpolymer hardener being used.

The invention relates to a heat-activable adhesive of low fluidity at high temperatures for bonding flexible printed conductor tracks (flexible printed circuit boards, FPCBs).

Flexible printed circuit boards are nowadays employed in a multiplicity of electronic devices such as mobile phones, radios, computers, printers and many more. They are constructed from layers of copper and a high-melting resistant thermoplastic: mostly polyimide, less often polyester. These FPCBs are frequently produced using adhesive tapes with particularly exacting requirements. On the one hand, for producing the FPCBs, the copper foils are bonded to the polyimide films; on the other hand, individual FPCBs are also bonded to one another, in which case polyimide bonds to polyimide. In addition to these applications, the FPCBs are also bonded to other substrates.

The adhesive tapes used for these bonding tasks are subject to very exacting requirements. Since very high bond performances must be attained, the adhesive tapes used are generally heat-activable tapes, which are processed at high temperatures. These adhesive tapes must not emit volatile constituents in the course of this high temperature load during the bonding of the FPCBs, which often takes place at temperatures around 200° C. In order to achieve a high level of cohesion the adhesive tapes ought to crosslink during this temperature load. High pressures during the bonding operation make it necessary for the flowability of the adhesive tapes at high temperatures to be low. This is achieved by high viscosity in the uncrosslinked adhesive tape or by very rapid crosslinking. Moreover, the adhesive tapes must also be solder bath resistant, in other words must for a short time withstand a temperature load of 288° C.

For this reason the use of pure thermoplastics is not rational, despite the fact that they melt very readily, ensure effective wetting of the substrates to be bonded and lead to very rapid bonding within a few seconds. At high temperatures, though, they are so soft that they tend to swell out of the bondline under pressure in the course of bonding. Accordingly there is no solder bath resistance either.

For crosslinkable adhesive tapes it is usual to use epoxy resins or phenolic resins, which react with specific hardeners to form polymeric networks. In this specific case the phenolic resins cannot be used, since in the course of crosslinking they generate elimination products, which are released and, in the course of curing or, at the latest, in the solder bath, lead to blistering.

Epoxy resins are employed primarily in structural adhesive bonding and, after curing with appropriate crosslinkers, produce very brittle adhesives, which indeed achieve high bond strengths but possess virtually no flexibility.

Increasing the flexibility is vital for use in FPCBs. On the one hand the bond is to be made using an adhesive tape which ideally is wound onto a roll; on the other hand the conductor tracks in question are flexible, and must also be bent, readily apparent from the example of the conductor tracks in a laptop, where the foldable screen is connected via FPCBs to the further circuits.

Flexibilizing these epoxy resin adhesives is possible in two ways. First, there exist epoxy resins flexibilized with elastomer chains, but the flexibilization they experience is limited, owing to the very short elastomer chains. The other possibility is to achieve flexibilization through the addition of elastomers, which are added to the adhesive. This version has the drawback that the elastomers are not crosslinked chemically, meaning that the only elastomers that can be used are those which at high temperatures still retain a high viscosity.

Because the adhesive tapes are produced generally from solution it is frequently difficult to find elastomers of a sufficiently long-chain nature not to flow at high temperatures while being still soluble in conventional solvents.

Production via a hotmelt operation is possible but very difficult in the case of crosslinking systems, since it is necessary to prevent premature crosslinking during the production operation.

Adhesives based on acid-modified acrylonitrile-butadiene copolymers (nitrile rubbers) and epoxy resins are known from JP 05 287 255 A, JP 11 061 073 A, JP 03 028 285 A and JP 61 076 579 A. In all of these cases, in addition to the carboxylated nitrile rubbers and the epoxy resins, hardeners for the epoxy resins are also added, preferably as amines. Although JP 11 181 380 A does not expressly mention the use of a hardener, the fraction of epoxy resin is so high that the epoxide groups are in a marked excess with respect to the acid groups of the modified nitrile rubber, so that complete crosslinking can only take place via an additional hardener. Moreover, the adhesive tape is very hard and not as flexible as desired, owing to the high epoxy resin fraction.

It is an object of the invention, therefore, to provide an adhesive tape which is heat-activable, crosslinks under heat, flows well under heat onto the substrate to be bonded, displays effective adhesion to polyimide, and in the uncrosslinked state is soluble in organic solvents.

This object is surprisingly achieved by means of an adhesive tape as characterized in more detail in the main claim. The dependent claims provide advantageous developments of the subject matter of the invention.

The invention accordingly provides a heat-activable adhesive tape for producing and further processing flexible conductor tracks, with an adhesive composed at least of
a) an acid- or acid anhydride-modified acrylonitrile-butadiene copolymer, and
b) an epoxy resin,
   the weight ratio of the two components a/b being greater than 1.5 and no additional nonpolymer hardener being used.

The general expression “adhesive tape” for the purposes of this invention embraces all sheetlike structures, such as two-dimensionally extended sheets or sheet sections, tapes with extended length and limited width, tape sections, diecuts, and the like.

An advantage of the adhesives of the invention is that the elastomer actually crosslinks chemically with the resin; the addition of a hardener for the epoxy resin is not necessary since the elastomer itself acts as hardener. The elastomer is thereby also incorporated in the network, which leads to a markedly increased strength of the crosslinked adhesive compared to adhesives in which only the epoxy resin is crosslinked with a hardener.

Nitrile rubbers which can be employed in particular in adhesives of the invention include all of acrylonitrile-butadiene copolymers having an acrylonitrile content of 15% to 50% by weight. Additionally, copolymers of acrylonitrile, butadiene and isoprene can also be used. In that case the fraction of 1,2-linked butadiene is variable. The aforementioned polymers may have various degrees of hydrogenation; fully hydrogenated polymers with a double bond fraction of below 1% can also be utilized.

All of these nitrile rubbers are carboxylated to a certain degree; the fraction of acid groups is preferably 2% to 15% by weight. Commercially, systems of this kind are obtainable, for example, under the name Nipol 1072 or Nipol NX 775 from the company Zeon. Hydrogenated carboxylated nitrile rubbers are commercialized under the name Therban XT VP KA 8889 from Lanxess.

Epoxy resins are usually understood to be not only monomeric but also oligomeric compounds containing more than one epoxide group per molecule. They may be reaction products of glycidyl esters or epichlorohydrin with bisphenol A or bisphenol F or mixtures of these two. Likewise suitable for use are epoxy novolak resins, obtained by reacting epichlorohydrin with the reaction product of phenols and formaldehyde. Monomeric compounds containing two or more epoxide end groups, used as diluents for epoxy resins, can also be employed. Likewise suitable for use are elastically modified epoxy resins.

Examples of epoxy resins are Araldite™ 6010, CY-281™, ECN™ 1273, ECN™ 1280, MY 720, RD-2 from Ciba Geigy, DER™ 331, 732, 736, DEN™ 432 from Dow Chemicals, Epon™ 812, 825, 826, 828, 830 etc. from Shell Chemicals, HPT™ 1071, 1079, likewise from Shell Chemicals, and Bakelite™ EPR 161, 166, 172, 191, 194 etc. from Bakelite AG.

Commercial aliphatic epoxy resins are, for example, vinylcyclohexane dioxides such as ERL-4206, 4221, 4201, 4289 or 0400 from Union Carbide Corp.

Elasticized elastomers are available from Noveon under the name Hycar.

Epoxy diluents, monomeric compounds containing two or more epoxide groups, are for example Bakelite™ EPD KR, EPD Z8, EPD HD, EPD WF, etc. from Bakelite AG or Polypox™ R9, R12, R 15, R 19, R 20 etc. from UCCP.

With further preference the adhesive tape comprises more than one epoxy resin.

In addition to the acid- or acid anhydride-modified nitrile rubbers already mentioned, further elastomers can also be used. In addition to further acid- or acid anhydride-modified elastomers, nonmodified elastomers can also be used, such as polyvinyl alcohol, polyvinyl acetate, styrene block copolymers, polyvinyl formal, polyvinyl butyral or soluble polyesters.

Copolymers with maleic anhydride such as a copolymer of polyvinyl methyl ether and maleic anhydride, which can be obtained for example under the name Gantrez™, marketed by ISP, can also be used.

The chemical crosslinking of the hardeners with the elastomers produces very high strengths within the adhesive film. The bond strengths to the polyimide as well, however, are extremely high.

In order to increase the adhesion it is also possible to add tackifier resins compatible with the elastomer.

Examples of tackifiers which can be used in pressure-sensitive adhesives of the invention include non-hydrogenated, partially hydrogenated or fully hydrogenated resins based on rosin and rosin derivatives, hydrated polymers of dicyclopentadiene, non-hydrogenated or partially, selectively or fully hydrogenated hydrocarbon resins based on C₅, C₅/C₉ or C₉ monomer streams, polyterpene resins based on α-pinene and/or β-pinene and/or δ-limonene, hydrogenated polymers of preferably pure C₈ and C₉ aromatics. Aforementioned tackifier resins may be used either alone or in a mixture.

Further additives which can be used typically include:
primary antioxidants, such as sterically hindered phenols
secondary antioxidants, such as phosphites or thioethers
in-process stabilizers, such as C-radical scavengers
light stabilizers, such as UV absorbers or sterically hindered amines
processing assistants
endblock reinforcer resins
fillers, such as silicon dioxide, glass (ground or in the form of beads), aluminum oxides, zinc oxides, calcium carbonates, titanium dioxides, carbon blacks, metal powders, etc.
color pigments and dyes and also optical brighteners.

Through the use of plasticizers it is possible to raise the elasticity of the crosslinked adhesive. Plasticizers which can be used include, for example, low molecular mass polyisoprenes, polybutadienes, polyisobutylenes or polyethylene glycols and polypropylene glycols.

Since the nitrile rubbers used do not have an excessively low viscosity even at high temperatures, there is no escape of adhesive from the bondline in the course of adhesive bonding or hot pressing. During this procedure, the epoxy resins crosslink with the elastomers to form a three-dimensional network.

By adding compounds known as accelerators it is possible to increase the reaction rate further.

Examples of possible accelerators include the following:
tertiary amines, such as benzyldimethylamine, dimethylaminomethylphenol, tris(dimethylaminomethyl)phenol
boron trihalide-amine complexes
substituted imidazoles
triphenylphosphine

Ideally the acid- or acid anhydride-modified elastomers and epoxy resins are employed in a proportion such that the molar fraction of epoxide groups and acid groups is just equivalent. Use of only slightly modified elastomers and use of low-molecular-weight epoxy resins with a low epoxide equivalent result in this case in only very small amounts of epoxy resin, under 10% by weight based on the modified nitrile rubber.

The ratio between acid groups and epoxide groups, however, can be varied within wide ranges; for sufficient crosslinking, neither of the two groups should be present in more than a four-fold molar equivalent excess.

To produce the adhesive tape the constituents of the adhesive are dissolved in a suitable solvent, butanone for example, and the solution is coated onto a flexible substrate provided with a release layer, such as a release paper or release film, for example, and the coating is dried, so that the composition can be easily removed again from the substrate. Following appropriate converting, diecuts, rolls or other shapes can be produced at room temperature. Corresponding shapes are then adhered, preferably at elevated temperature, to the substrate to be bonded, polyimide for example.

It is also possible to coat the adhesive directly onto a polyimide backing. Adhesive sheets of this kind can then be used for masking copper conductor tracks for FPCBs.

It is not necessary for the bonding operation to be a one-stage process; instead, the adhesive tape can first be adhered to one of the two substrates by carrying out hot lamination. In the course of the actual hot bonding operation with the second substrate (second polyimide sheet or copper foil), the resin then fully or partly cures and the bondline reaches the high bond strength.

The admixed epoxy resins should preferably not yet enter into any chemical reaction at the lamination temperature, but instead should react with the acid or acid anhydride groups only on hot bonding.

The adhesive tape crosslinks preferably at temperatures above 150° C.

### EXAMPLES

The invention is described in more detail below by a number of examples, without restricting the invention in any way whatsoever.

### Example 1

80 parts by weight of Nipol NX 775 (nitrile rubber with 26% by weight of acrylonitrile and 7% by weight of acid modification from Zeon) are dissolved in butanone with 20 parts by weight of Bakelite EPR 166 (epoxy resin with an epoxide equivalent of 184, from Bakelite) and then the solution is coated out onto a release paper which has a release layer, to give, after drying, a coat thickness of 25 μm.

### Example 2

20 parts by weight of Piccolyte A 125 (polyterpene resin from Hercules) are added to example 1 and likewise dissolved in butanone. The subsequent procedure is as described in example 1.

### Example 3, Comparative

75 parts by weight of Breon N41H80 (nitrile rubber from Zeon with an acrylonitrile content of 41% by weight and a Mooney viscosity ML 1+4 at 100° C. of 72 to 88) and 25 parts by weight of Bakelite EPR 166 are dissolved in butanone and coated out as described above.

### Example 4, Comparative

70 parts by weight of Breon are dissolved in butanone with 25 parts by weight of EPR 166 and 5 parts by weight of Dyhard 100-S (dicyandiamide from Degussa) and then coated out.

Bonding of FPCBs with the Adhesive Tape Produced

Two FPCBs are bonded using in each case one of the adhesive tapes produced in accordance with examples 1 to 4. For this purpose the adhesive tape is laminated onto the polyimide sheet of the polyimide/copper foil FPCB laminate at 100° C., the adhesive strip being somewhat shorter than the FPCB that is to be bonded, so as subsequently to have a grip tab. Subsequently a second polyimide sheet of a further FPCB is bonded to the adhesive tape and the whole assembly is compressed in a heatable Burkle press at 200° C. and a pressure of 1.3 MPa for one hour.

### Test Methods

The properties of the adhesive sheets produced in accordance with the examples specified above are investigated by the following test methods.

T-Peel Test with FPCB

Using a tensile testing machine from Zwick, the FPCB/adhesive tape/FPCB assemblies produced in accordance with the process described above are peeled from one another at an angle of 180° and with a rate of 50 mm/min, and the force required, in N/cm, is measured. The measurements are made at 20° C. and 50% relative humidity. Each measurement value is determined three times.

### Temperature Stability

In analogy to the T-peel test described, the FPCB assemblies produced in accordance with the process described above are suspended so that one of the two grip tabs formed is fixed at the top, while on the other grip tab a weight of 500 g is fastened, so that an angle of 180° is formed between the two FPCBs. The static peel test takes place at 70° C. The parameter measured is the static peel travel in mm/h.

### Solder Bath Resistance

The FPCB assemblies bonded in accordance with the process described above are laid for 10 seconds onto a solder bath which is at a temperature of 288° C. The bond is rated solder bath resistant if there is no formation of air bubbles which cause the polyimide sheet of the FPCB to inflate. The test is rated as failed if there is even slight formation of bubbles.

### Results:

For adhesive assessment of the abovementioned examples the T-peel test was conducted first of all.

The results are given in Table 1.

TABLE 1

| | T-peel test [N/cm] |
|---|---|
| Example 1 | 12.6 |
| Example 2 | 14.3 |
| Example 3 | 2.7 |
| Example 4 | 10.7 |

The bond strength in the samples which no longer comprise any hardener in addition to the acid-modified elastomers is greater than in the sample which uses unmodified nitrile rubber but requires an additional hardener. Without crosslinking (example 3) the bond strength is only very low.

The temperature stability of the adhesive tapes was measured using the static peel test, whose values can be found in Table 2.

TABLE 2

| | Static T-peel test at 70° C. [mm/h] |
|---|---|
| Example 1 | 5 |
| Example 2 | 7 |
| Example 3 | >50 |
| Example 4 | 16 |

As can be seen, the temperature stability in the case of the reference specimens is less than in the case of examples 1 and 2.

The solder bath test was passed by all 4 examples.

1-9. (canceled)

10. A method of bonding flexible printed conductor tracks, which comprises bonding said flexible printed conductor tracks with a heat-activable adhesive tape having an adhesive comprised of
a. an acid- or acid anhydride-modified acrylonitrile-butadiene copolymer; and
b. an epoxy resin,
the weight ratio of the two components a/b being greater than 1.5, and no additional nonpolymer hardener.

11. The method of claim 10, wherein the acid- or acid anhydride-modified acrylonitrile-butadiene copolymer is at least partly hydrogenated.

12. The method of claim 10 wherein the acrylonitrile content of the acrylonitrile-butadiene copolymer is 15% to 50% by weight.

13. The method of claim 10, wherein the adhesive comprises more than one epoxy resin.

14. The method of claim 10, wherein the adhesive comprises one or more of tackifying resins, accelerators, dyes, carbon black and metal powders.

15. The method of claim 10, wherein the adhesive crosslinks at temperatures above 150° C.

16. The method of claim 10, wherein the adhesive further comprises additional elastomers.

17. A method for bonding an article to polyimide, which comprises bonding said article to said polyimide with a heat-activable adhesive tape having an adhesive comprised of
c. an acid- or acid anhydride-modified acrylonitrile-butadiene copolymer, and
d. an epoxy resin,
the weight ratio of the two components a/b being greater than 1.5, and no additional nonpolymer hardener.

18. The method of claim 17, wherein the acid- or acid anhydride-modified acrylonitrile-butadiene copolymer is at least partly hydrogenated.

19. The method of claim 17 wherein the acrylonitrile content of the acrylonitrile-butadiene copolymer is 15% to 50% by weight.

20. The method of claim 17, wherein the adhesive comprises more than one epoxy resin.

21. The method of claim 17, wherein the adhesive comprises one or more of tackifying resins, accelerators, dyes, carbon black and metal powders.

22. The method of claim 17, wherein the adhesive crosslinks at temperatures above 150° C.

23. The method of claim 17, wherein the adhesive further comprises additional elastomers.
